(19) United States
(12) Patent Application Publication
(10) Pub. No.: US 2026/0326644 A1
(43) Pub. Date: Oct. 22, 2026

(54) MODULAR ROTARY DAMPENER FOR HIGH TORQUE APPLICATIONS

(71) Applicants: David M. RUNDE, Ortonville, MI (US); Kristof M. KURZEJA, Commerce Township, MI (US); MAGNA SEATING INC., Aurora (CA)

(72) Inventors: David M. Runde, Ortonville, MI (US); Kristof M. Kurzeja, Commerce Township, MI (US)

(21) Appl. No.: 19/114,756

(22) PCT Filed: Sep. 25, 2023
(86) PCT No.: PCT/US2023/033584

§ 371 Date: Mar. 24, 2025

Related U.S. Application Data
(60) Provisional application No. 63/409,296, filed on Sep. 23, 2022.

(51) Int. Cl. B60N 2/90; B60N 2/22

(52) U.S. Cl. CPC B60N 2/933; B60N 2/22

(57) ABSTRACT

A rotary dampener for an automotive seat assembly includes an inboard cover (30), a pivot pin (54) fixedly coupled to the inboard cover, an actuating bracket (106) pivotably coupled to the pivot pin (54) and including an actuating tab (112), a leaf spring (182) fixedly coupled to the inboard cover (30), and a dampener roller (122) coupled to the actuating bracket (106) and configured to frictionally engage with the leaf spring (182) as the actuating bracket rotates in a forward rotational direction. The rotary dampener also includes an outboard cover (154) pivotably coupled to the pivot pin (54) and fixedly coupled to the actuating tab (106). When the outboard cover (154) is rotated relative to the inboard cover (30) in the forward rotational direction, the rotary dampener dampens a rotational velocity of the outboard cover (154) while the dampener roller (122) is frictionally engaged with the leaf spring (182) and the rotational velocity is undampened while the dampener roller (122) is disengaged from the leaf spring (182).

### CROSS-REFERENCE TO RELATED APPLICATIONS

This application claims priority to U.S. Provisional Application 63/409,296, filed on Sep. 23, 2022, the disclosure of which is hereby incorporated by reference in its entirety.

### FIELD AND BACKGROUND OF THE INVENTION

The present invention relates to a seat assembly for use in an automotive vehicle. More particularly, the invention relates to a modular rotary dampener for use in an automotive seat assembly.

### DESCRIPTION OF RELATED ART

Automotive vehicles typically include one or more seat assemblies having a seat cushion and a seat back for supporting a passenger above a vehicle floor. It is commonly known for the seat back to be pivotable between a reclined position, an upright position, and a fold flat position with the seat back overlying the seat cushion. It is commonly known for the seat assembly to include a disc recliner configured to lock the seat back into one or more inclination positions. A release handle is provided to unlock the disc recliner when the release handle is actuated. In addition, it is commonly known for seat assemblies to include a seat back return spring(s) configured to bias the seat back towards the upright position and optionally towards the fold flat position.

To adjust the seat back from the reclined position to the upright position, the occupant actuates the release handle, unlocking the disc recliner. After the disc recliner is unlocked, the seat back return spring(s) automatically moves the seat back to the upright position. Once the seat back is adjusted, the occupant releases the release handle, and the disc recliner relocks. To reconfigure the seat assembly for cargo carrying, the occupant actuates the release handle while standing outside the vehicle to unlock the disc recliner. Next, the return spring(s) or the occupant pivots the seat back from the upright position towards the fold flat position.

Certain rear seat assemblies include a split seat back comprising a 60% seat back and a 40% seat back. The force or torque required to reposition the 60% seat back from the reclined position to the upright position is relatively large due to the weight of the 60% seat back. Thus, rear seat assemblies commonly include strong seat back return spring(s) attached to the 60% seat back. However, the strong seat back return spring(s) and/or the weight of the seat back may cause excessive seat back velocity when pivoting the seat back from the upright position to the fold flat position.

It is desirable for the seat assemblies to include a dampener configured to reduce the seat back velocity as the seat back is rotated from the upright position towards the fold flat position.

### SUMMARY OF THE INVENTION

According to one embodiment, there is provided a rotary dampener for an automotive seat assembly. The rotary dampener includes an inboard cover, a pivot pin fixedly coupled to the inboard cover, an actuating bracket pivotably coupled to the pivot pin and including an actuating tab, and a leaf spring having a head end fixedly coupled to the inboard cover and a free end spaced apart from the head end. In addition, the rotary dampener includes a dampener roller coupled to the actuating bracket and configured to selectively engage with the leaf spring as the actuating bracket rotates in a forward rotational direction and selectively disengage from the leaf spring as the actuating bracket rotates in a rearward rotational direction opposite the forward rotational direction. The rotary dampener also includes an outboard cover pivotably coupled to the pivot pin and fixedly coupled to the actuating tab such that the outboard cover and the actuating bracket rotate together. When the outboard cover is rotated relative to the inboard cover in the forward rotational direction, the rotary dampener dampens a rotational velocity of the outboard cover while the dampener roller is engaged with the leaf spring and the rotational velocity is undampened while the dampener roller is disengaged from the leaf spring.

According to another embodiment, there is provided a seat assembly for use in an automotive vehicle. The seat assembly includes a seat cushion, a seat back pivotably coupled to the seat cushion and pivotable between a first seat back position and a second seat back position, and a rotary dampener operatively coupled between the seat back and the seat cushion. The rotary dampener includes an inboard cover fixedly coupled to the seat cushion, a pivot pin fixedly coupled to the inboard cover, and an actuating bracket pivotably coupled to the pivot pin and including an actuating tab. The rotary dampener also includes a leaf spring having a head end fixedly coupled to the inboard cover and a free end spaced apart from the head end. In addition, the rotary dampener includes a dampener roller coupled to the actuating bracket and configured to selectively engage with the leaf spring as the actuating bracket rotates in a forward rotational direction. Further, the rotary dampener also includes an outboard cover fixedly coupled to the seat back, pivotably coupled to the pivot pin, and fixedly coupled to the actuating tab such that the outboard cover and the actuating bracket rotate together. The rotary dampener dampens a rotational velocity of the seat back when the seat back is rotated in the forward rotational direction while the dampener roller is engaged with the leaf spring and the rotational velocity is undampened while the dampener roller is disengaged from the leaf spring.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 is a perspective view of a seat assembly including a seat cushion, a seat back, and a rotary dampener, according to one embodiment of the present invention;

FIG. 2 is an enlarged view of portion 2 of FIG. 1;

FIG. 3 is a rear left perspective view of the rotary dampener of FIG. 2;

FIG. 4 is a front right perspective view of the rotary dampener of FIG. 3;

FIG. 5 is a left side view of the rotary dampener of FIG. 4 with the rotary dampener in a rearward condition;

FIG. 6 is an exploded view of the rotary dampener of FIG. 5 including a pivot pin and a leaf spring;

FIG. 7 is a perspective view of the pivot pin of FIG. 6;

FIG. 8 is a perspective view of the leaf spring of FIG. 6;

FIG. 9 is a left side view of the rotary dampener of FIG. 5 with the rotary dampener in the rearward condition and the outboard cover removed;

FIG. 10 is a cross-sectional view of the rotary dampener of FIG. 5 taken along section 10-10 in FIG. 5;

FIG. 11 is a cross-sectional view of the rotary dampener of FIG. 5 taken along section 11-11 in FIG. 5;

FIG. 12 is a schematic view of a seat assembly illustrating a recline position, an upright position, and a fold flat position of the seat back, according to one embodiment of the present invention;

FIG. 13 is a left side view of the rotary dampener of FIG. 5 with the rotary dampener in an upright condition;

FIG. 14 is a left side view of the rotary dampener of FIG. 13 with the rotary dampener in the upright condition and the outboard cover removed;

FIG. 15 is an enlarged perspective view of portion 15 of FIG. 14 with the rotary dampener in a dampening condition;

FIG. 16 is a left side view of the rotary dampener of FIG. 13 with the rotary dampener in a forward condition;

FIG. 17 is a left side view of the rotary dampener of FIG. 16 with the rotary dampener in the forward condition and the outboard cover removed;

FIG. 18 is a left side view of a rotary dampener, according to another embodiment of the present invention; and

FIG. 19 is a left side view of the rotary dampener of FIG. 18 with the outboard cover removed.

### DETAILED DESCRIPTION OF THE INVENTION

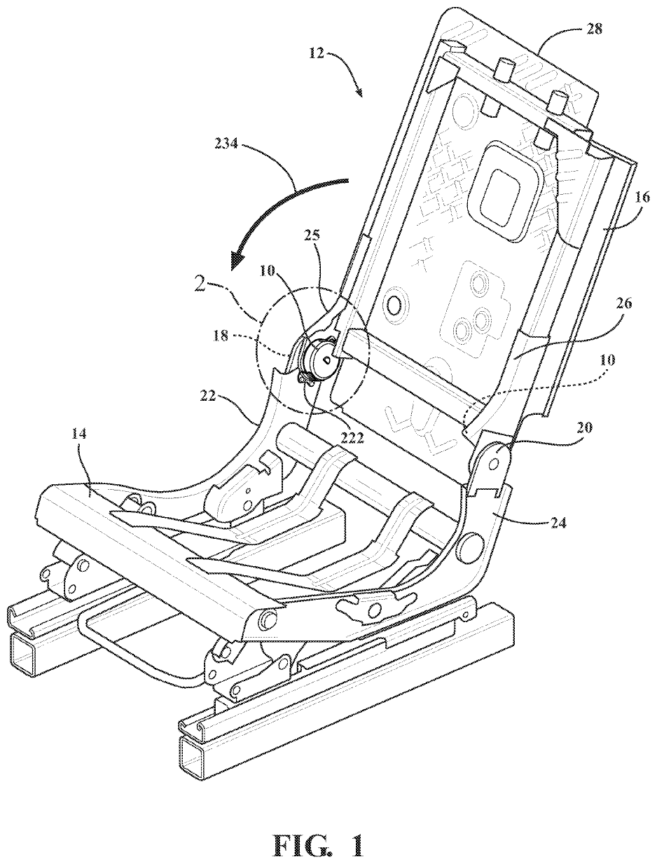

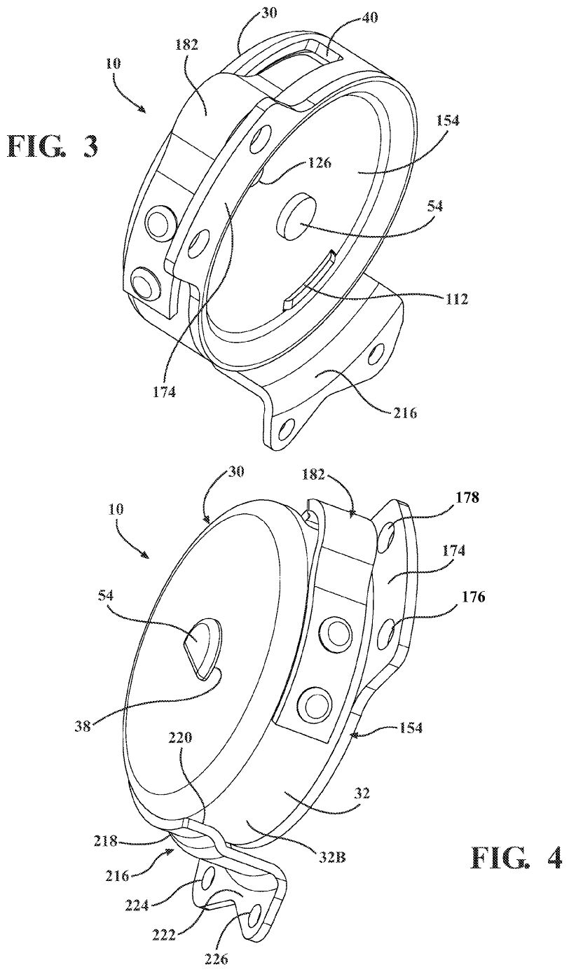

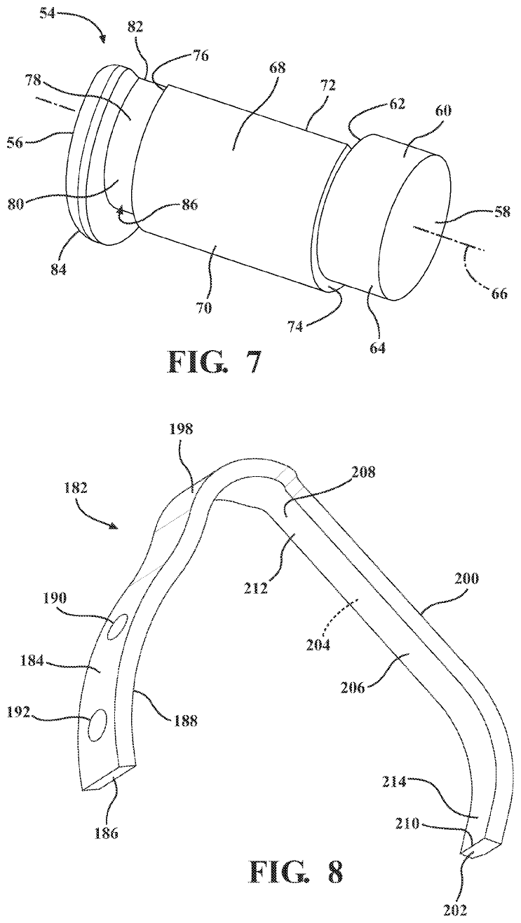

FIGS. 1-19 illustrate components of a rotary dampener 10 for use in a seat assembly 12 of an automotive vehicle according to embodiments described herein. Directional references employed or shown in the description, figures, or claims, such as top, bottom, upper, lower, upward, downward, lengthwise, widthwise, left, right, and the like, are relative terms employed for ease of description and are not intended to limit the scope of the invention in any respect. Referring to the Figures, like numerals indicate like or corresponding parts throughout the several views.

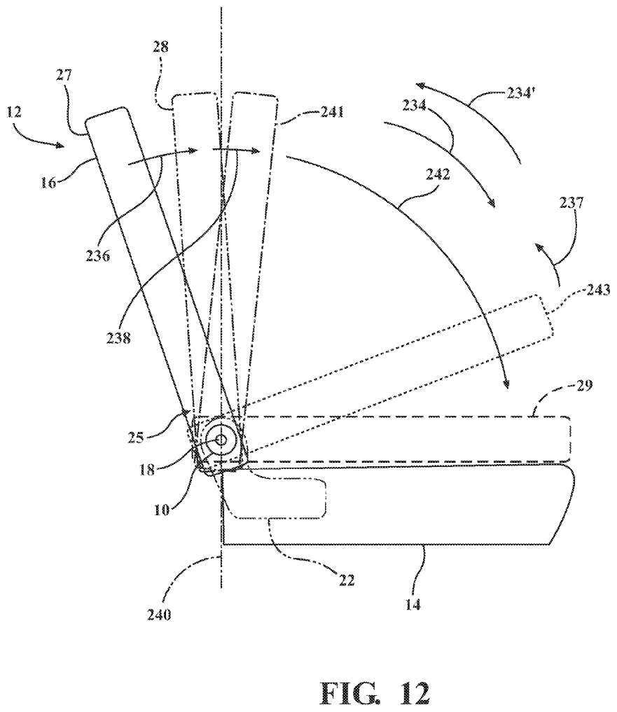

Depicted in FIG. 1, the seat assembly 12 includes a seat cushion 14 and a seat back 16 pivotably coupled to the seat cushion 14 by laterally spaced apart pivots 18, 20. The seat cushion 14 and the seat back 16 are shown with the padding and covers removed for illustrative purposes. The seat cushion 14 includes laterally spaced apart cushion brackets 22, 24. In addition, the seat back 16 includes laterally spaced apart side brackets 25, 26. The pivots 18, 20 pivotally couple the side brackets 25, 26 to the respective cushion brackets 22, 24. As illustrated in FIG. 12, the seat back 16 is pivotable between a reclined position 27, an upright position 28, and a fold flat position 29 overlying the seat cushion 14. The seat back 16 is shown in the upright position 28 in FIG. 1.

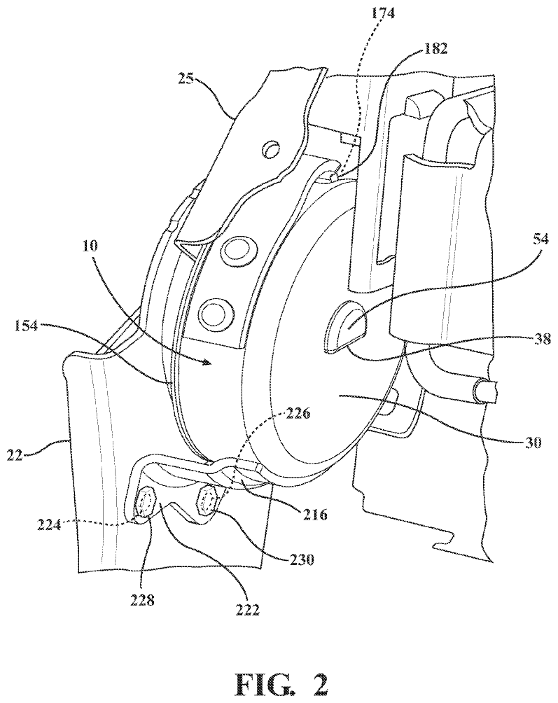

Shown in FIGS. 1 and 2, the seat assembly 12 also includes the rotary dampener 10 operatively coupled between the side bracket 25 and the cushion bracket 22. The rotary dampener 10 is configured to selectively dampen the rotational velocity of the seat back 16 as the seat back 16 is rotated from the upright position 28 towards the fold flat position 29. In addition, the rotary dampener 10 is configured to spring-bias the seat back 16 towards the upright position 28 when the seat back 16 is in the reclined position 27. The seat assembly 12 optionally includes a second rotary dampener 10 operatively coupled between the other side bracket 26 and the other cushion bracket 24. In addition, it will be appreciated that the rotary dampener 10 might be operatively coupled between different first and second components of the seat assembly 12 without altering the scope of the present invention.

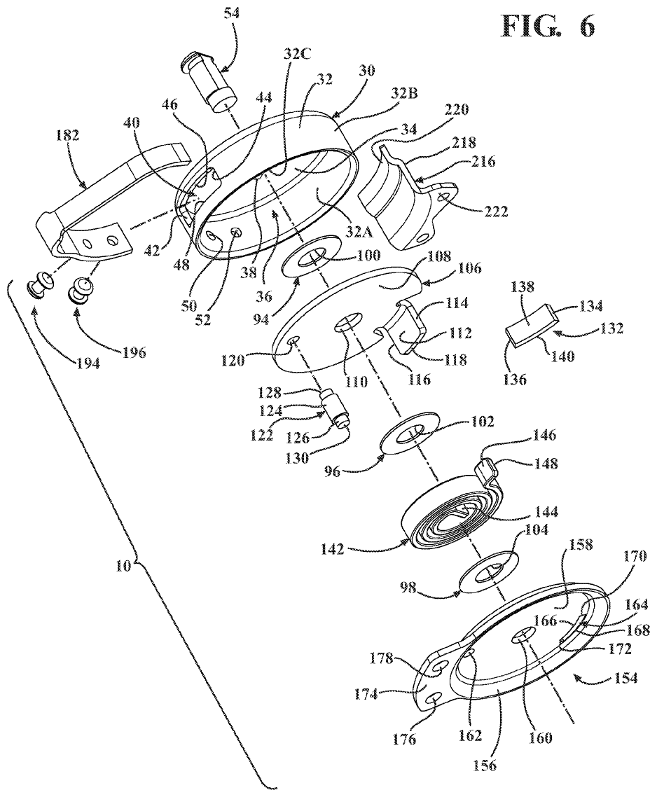

Referring to FIGS. 2-11, the rotary dampener 10 includes an inboard cover 30 having a generally cylindrical shape. Depicted in FIG. 6, the inboard cover 30 includes a cylindrical wall 32 projecting laterally away from an inboard wall 34 and defining an internal cavity 36. The inboard wall 34 includes a D-shaped hole 38 extending laterally therethrough. The cylindrical wall 32 includes radially spaced apart inner and outer cylindrical surfaces 32A, 32B extending around an outer perimeter of the inboard wall 34 and terminating at a lip 32C. In addition, the cylindrical wall 32 includes a slot 40 extending in a circumferential direction between opposing slot ends 42, 44 and between opposing slot sides 46, 48. In addition, the slot 40 extends through the cylindrical wall 32 and adjoins the internal cavity 36. The cylindrical wall 32 also includes circumferentially spaced apart mounting holes 50, 52 extending radially through the cylindrical wall 32 and spaced apart from the slot 40.

Shown in FIGS. 6, 7, 10, and 11, the rotary dampener 10 also includes a pivot pin 54 having a generally cylindrical shape and extending between opposing inboard and outboard ends 56, 58. The pivot pin 54 includes a pivot boss 60 having a generally cylindrical shape which extends laterally inward from the outboard end 58 and terminates at a boss end 62. In addition, the pivot boss 60 includes an outer pivot surface 64 extending circumferentially around the pivot boss 60 which defines an axis of rotation 66. The pivot pin 54 also includes a spring arbor 68 extending axially away from the boss end 62. The spring arbor 68 is a generally D-shaped cylinder with a curved surface 70 extending in a circumferential direction and adjoining a flat surface 72 to form a D-shape in cross-section. The curved and flat surfaces 70, 72 extend axially between opposing outboard and inboard ends 74, 76. The spring arbor 68 adjoins the pivot boss 60 such that a portion of the outboard end 74 protrudes radially away from the pivot surface 64 forming an outboard ledge extending circumferentially along a portion of the pivot surface 64. In addition, the flat surface 72 abuts the boss end 62 such that a portion of the boss end 62 extends radially away from the flat surface 72 forming a boss ledge.

The pivot pin 54 also includes a D-shaped boss 78 extending axially away from the inboard end 76 of the spring arbor 68. The D-shaped boss 78 includes a curved surface 80 extending in a circumferential direction and adjoining a flat surface 82 to form a D-shape in cross-section. The curved and flat surfaces 80, 82 extend axially between the inboard end 76 of the spring arbor 68 and a flange 84. The curved surface 70 of the spring arbor 68 is radially offset from the curved surface 80 of the D-shaped boss 78 such that a portion of the inboard end 76 forms an inboard ledge extending circumferentially along at least a portion of the curved surface 80 of the D-shaped boss 78. In addition, the flat surface 82 is generally radially aligned with the flat surface 72 of the spring arbor 68. However, it will be appreciated that the flat surfaces 72, 82 might be radially offset and/or non-parallel to each other. The flange 84 extends circumferentially along at least a portion of the curved surface 80 defining a channel 86 between the flange 84 and the inboard end 76. It will be appreciated that the flange 84 might be formed after the pivot pin 54 is assembled with the inboard cover 30.

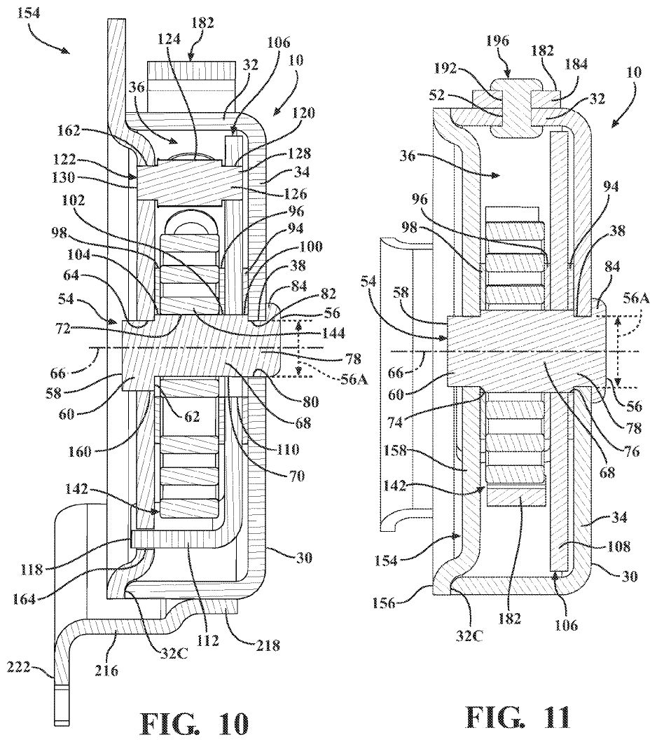

As illustrated in FIGS. 10 and 11, the D-shaped boss 78 might include a D-shaped end 56A sized and shaped to pass at least partially through the D-shaped hole 38 in the inboard cover 30. During assembly, the D-shaped end 56A of the pivot pin 54 is inserted into the internal cavity 36 in the inboard cover 30 and at least partially through the D-shaped hole 38. Next, the D-shaped end 56A of the pivot pin 54 might be riveted or staked to form the flange 84 and fixedly couple the inboard cover 30 to the pivot pin 54. The D-shaped end 56A of the pivot pin 54 in combination with the D-shaped hole 38 in the inboard cover 30 prevents relative rotation between the pivot pin 54 and the inboard cover 30.

Depicted in FIG. 6, the rotary dampener 10 also includes first and second inner spacers 94, 96, and an outer spacer 98. The spacers 94, 96, 98 are generally ring-shaped and have a respective passageway 100, 102, 104 extending axially therethrough. As illustrated in FIGS. 10 and 11, the spacers 94, 96, 98 are assembled on the pivot pin 54 spaced apart along the spring arbor 68 with the pivot pin 54 extending axially through the passageways 100, 102, 104 in the spacers 94, 96, 98.

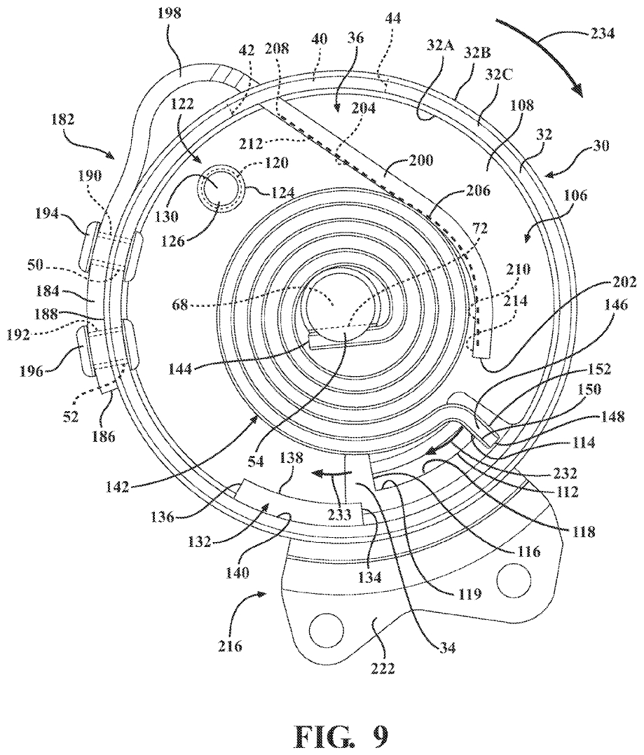

Shown in FIG. 6, the rotary dampener 10 also includes an actuating bracket 106 comprising a main disc 108 having a center hole 110 extending axially therethrough and an actuating tab 112 projecting axially from the main disc 108. The actuating tab 112 includes an engagement surface 114 and an opposing side surface 116 extending generally in the axial direction and terminating at a distal wall 118. Shown in FIG. 9, the actuating tab 112 includes a distal surface 119 extending circumferentially between the engagement surface 114 and the side surface 116. Referring to FIG. 6, the actuating bracket 106 also includes a roller hole 120 extending axially through the main disc 108 and radially offset from the center hole 110. Depicted in FIGS. 9-11, the actuating bracket 106 is sized and shaped to fit within the internal cavity 36 of the inboard cover 30 with a portion of the actuating tab 112 optionally extending axially outward of the internal cavity 36. When assembled as part of the rotary dampener 10, the actuating bracket 106 is spaced between the first and second inner spacers 94, 96 with the pivot pin 54 extending through the center hole 110 in the actuating bracket 106 and the first inner spacer 94 positioned between the inboard wall 34 of the inboard cover 30 and the actuating bracket 106. In addition, the actuating bracket 106 is assembled on the pivot pin 54 with the actuating tab 112 oriented away from the inboard wall 34 of the inboard cover 30.

Also depicted in FIG. 6, the rotary dampener 10 includes a dampener roller 122. The dampener roller 122 includes a roller 124 having a generally cylindrical shape. In addition, the dampener roller 122 includes a roller pin 126 extending axially through the roller 124 and having inboard and outboard ends 128, 130. It will be appreciated that the roller 124 might be integrally formed with, rotationally coupled to, or fixedly coupled to the roller pin 126 without altering the scope of the present invention. Referring to FIG. 10, the dampener roller 122 is assembled with the actuating bracket 106 by inserting the inboard end 128 of the roller pin 126 into the roller hole 120 in the actuating bracket 106.

Shown in FIGS. 6, 9, and 15, the rotary dampener 10 also includes a spring stop 132 having a generally arcuate shape extending between a leading surface 134 and a trailing surface 136. In addition, the spring stop 132 includes radially spaced apart inner and outer walls 138, 140 sized and shaped to allow the outer wall 140 to be fixedly coupled to the inner cylindrical surface 32A of the inboard cover 30. After assembly with the inboard cover 30, the inner wall 138 of the spring stop 132 is spaced radially outward of the distal surface 119 of the actuating tab 112. The spring stop 132 is positioned on the inner cylindrical surface 32A of the inboard cover 30 such that there is axial clearance between the spring stop 132 and the main disc 108 of the actuating bracket 106. It will be appreciated that the spring stop 132 might be integrally formed with the inboard cover 30 without altering the scope of the present invention.

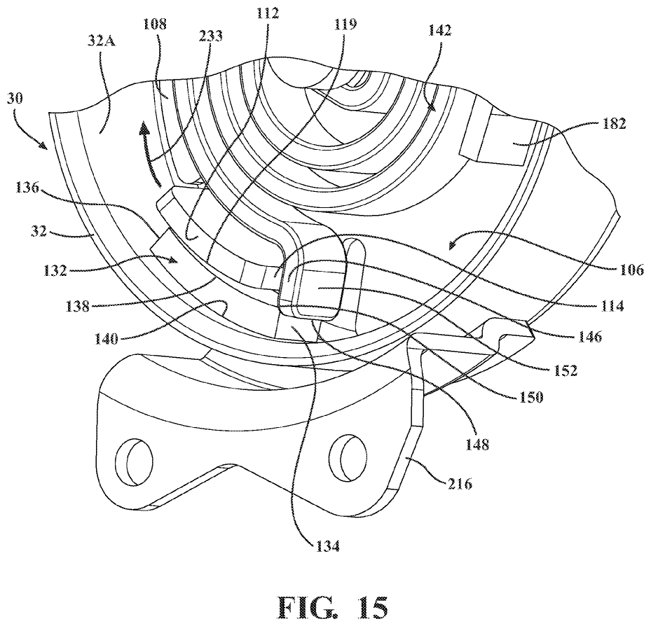

Depicted in FIGS. 6, 9, and 15, the rotary dampener 10 also includes a clock spring 142, alternatively described as a spiral torsion spring. The clock spring 142 is configured to spring-bias the seat back 16 from the reclined position 27 towards the upright position 28. The spring stop 132 prevents the clock spring 142 from spring-biasing the seat back 16 towards the fold-flat position 29 while the rotary dampener 10 is dampening the forward rotation of the seat back 16, as further described below. The clock spring 142 includes an inner end 144 configured to frictionally engage with or be fixedly coupled to the flat surface 72 on the spring arbor 68 on the pivot pin 54. The clock spring 142 also includes a tab 146 extending radially inward from an outer end 148 and having a forward surface 150 opposing a rearward surface 152. Shown in FIG. 9, the forward surface 150 is configured to frictionally engage with the engagement surface 114 on the actuating tab 112. Referring to FIG. 15, the forward surface 150 is also configured to frictionally engage with the leading surface 134 of the spring stop 132. During assembly of the rotary dampener 10, the clock spring 142 is assembled on the pivot pin 54 and spaced axially between the second inner spacer 96 and the outer spacer 98, as shown in FIG. 10.

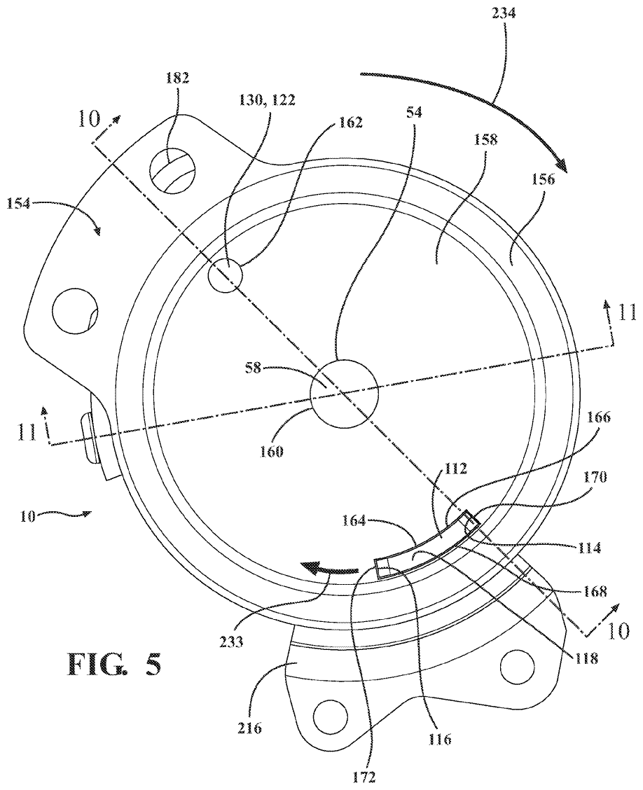

Depicted in FIGS. 5, 6, and 11, the rotary dampener 10 also includes an outboard cover 154 configured to be pivotably coupled to the pivot pin 54 and the inboard cover 30. The outboard cover 154 is generally disc-shaped with an outer rim 156 extending radially outward from and circumferentially around a disc-shaped central portion 158. The outer rim 156 is configured to matingly and rotationally engage with the lip 32C on the inboard cover 30 when the outboard cover 154 is assembled with the inboard cover 30, as illustrated in FIG. 11. It will be appreciated that the outer rim 156 might be axially spaced apart from the cylindrical wall 32 on inboard cover 30 without altering the scope of the present invention.

Referring to FIG. 6, the outboard cover 154 also includes a pivot hole 160, a pin hole 162, and a bracket slot 164 which are spaced apart and extend axially through the central portion 158. Also shown in FIG. 10, the pivot hole 160 is sized and shaped to rotationally couple with the pivot boss 60 on the pivot pin 54 after the pivot pin 54 is assembled with the inboard cover 30 and the outboard cover 154 is assembled with the inboard cover 30. In addition, the pin hole 162 is sized and shaped to matingly engage with the outboard end 130 of the roller pin 126 when the outboard cover 154 is assembled with the inboard cover 30 after the dampener roller 122 is assembled with the actuating bracket 106. Referring to FIG. 6, the bracket slot 164 is an arcuate-shaped slot having radially spaced apart inner and outer walls 166, 168 extending between opposing first and second ends 170, 172. The bracket slot 164 is sized and shaped to matingly engage with the actuating tab 112 with the distal wall 118 inserted at least partially through the bracket slot 164 when the outboard cover 154 is assembled with the inboard cover 30, as shown in FIGS. 5 and 10.

Depicted in FIGS. 4 and 6, the outboard cover 154 also includes an attach flange 174 projecting generally radially outward from the outer rim 156. The attach flange 174 includes spaced apart attachment holes 176, 178 extending axially through the attach flange 174. During assembly of the rotary dampener 10 with the seat assembly 12, bolts (not shown) are inserted through the respective attachment holes 176, 178 and fixedly coupled to the side bracket 25 of the seat back 16.

Referring to FIGS. 6, 8, and 9, the rotary dampener 10 also includes a leaf spring 182. Depicted in FIGS. 8 and 9, the leaf spring 182 is a bent flat spring configured to engage with the dampener roller 122 and provide dampening as the dampener roller 122 moves along the leaf spring 182. The leaf spring 182 is shown in a load-free state in FIG. 8. The leaf spring 182 includes a base portion 184 extending from a head end 186 and having generally an arcuate shape with an inner surface 188 configured to matingly engage with the outer cylindrical surface 32B of the inboard cover 30, as shown in FIG. 9. In addition, the base portion 184 includes spaced apart rivet holes 190, 192 extending therethrough and configured to align with the mounting holes 50, 52, respectively, on the inboard cover 30. Referring to FIGS. 6, 9, and 11, the rotary dampener 10 also includes rivets 194, 196 inserted through the respective rivet holes 190, 192 and the respective mounting holes 50, 52 fixedly coupling the base portion 184 of the leaf spring 182 to the inboard cover 30.

Shown in FIGS. 8 and 9, the leaf spring 182 also includes a bent portion 198 extending from the base portion 184 and adjoining a curved portion 200 which terminates at a free end 202. The curved portion 200 includes a roller interface zone 204 extending along an inner surface 206 of the curved portion 200 between an upper end 208 and a lower end 210. In addition, the curved portion 200 includes a minimum dampening location 212 near the upper end 208 of the roller interface zone 204 and a maximum dampening location 214 near the lower end 210 of the roller interface zone 204. It will be appreciated that the leaf spring 182 might have any profile and/or geometry that will allow the required dampening forces when activated by the dampener roller 122. Depicted in FIG. 9, the leaf spring 182 is sized and shaped such that the curved portion 200 might be inserted through the slot 40 in the cylindrical wall 32 of the inboard cover 30 prior to the leaf spring 182 being fixedly coupled to the inboard cover 30 by the rivets 194, 196. As assembled, the leaf spring 182 extends through the slot 40 between the opposing slot ends 42, 44 and into the internal cavity 36 in the inboard cover 30. The slot 40 and the leaf spring 182 are sized and shaped such that the slot 40 provides clearance allowing the leaf spring 182 to flex as the dampener roller 122 travels along the roller interface zone 204. Shown in FIG. 11, the leaf spring 182 is positioned axially between the main disc 108 of the actuating bracket 106 and the outboard cover 154 and is generally axially aligned with the clock spring 142.

Depicted in FIGS. 2, 4 and 6, the rotary dampener 10 also includes a lower bracket 216 configured to be fixedly coupled to the cushion bracket 22. Referring to FIGS. 4 and 6, the lower bracket 216 includes an arcuate-shaped flange 218 having an inner surface 220 configured to matingly engage with the outer cylindrical surface 32B of the inboard cover 30. During assembly, the inner surface 220 of the arcuate-shaped flange 218 is fixedly coupled to the outer cylindrical surface 32B. The lower bracket 216 also includes a base flange 222 extending at generally a right angle from the arcuate-shaped flange 218 and including spaced apart holes 224, 226 extending therethrough. As depicted in FIG. 2, the inboard cover 30 is fixedly coupled to the cushion bracket 22 by bolts 228, 230 inserted into the respective holes 224, 226 in the base flange 222 and fixedly coupled to holes (not shown) in the cushion bracket 22.

Referring to FIG. 12, the seat back 16 of the seat assembly 12 can be repositioned upon demand by the occupant between the reclined position 27, the upright position 28, and the fold flat position 29 by pivoting the seat back 16 about the pivots 18, 20. Referring to FIG. 2, the rotary dampener 10 is operatively coupled to the seat assembly 12 by the attach flange 174 on the outboard cover 154 fixedly coupled to the side bracket 25 and by the base flange 222 on the lower bracket 216 fixedly coupled to the cushion bracket 22. While not shown in the Figures, the seat assembly 12 includes a lock mechanism, such as a disc recliner, configured to lock the seat back 16 into a selected rotational position as is commonly known in the art. The occupant selectively unlocks the lock mechanism (not shown) to allow the position of the seat back 16 to be adjusted.

The rotary dampener 10 is shown in the rearward condition in FIGS. 5 and 9 which corresponds to the seat back 16 being in the reclined position 27 (FIG. 12). Depicted in FIG. 2, the pivot pin 54 is keyed to D-shaped hole 38 in the inboard cover 30 which in turn is fixedly coupled to the cushion bracket 22 by the lower bracket 216. As such, the pivot pin 54 does not rotate relative to the lower bracket 216 and the cushion bracket 22. Referring to FIG. 9, the spring stop 132 is fixedly coupled to the inboard cover 30 such that the leading surface 134 on the spring stop 132 does not rotate relative to the lower bracket 216. While the base portion 184 of the leaf spring 182 is fixedly coupled to the inboard cover 30, the free end 202 of the leaf spring 182 can flex and change position relative to the lower bracket 216. Further, the outboard cover 154 is pivotably coupled to the pivot pin 54 and fixedly coupled to the actuating tab 112, as depicted in FIG. 10. Referring to FIG. 9, it will be appreciated that the rearward surface 152 of the clock spring tab 146 might be frictionally engaged with or circumferentially spaced apart from the free end 202 of the leaf spring 182 when the rotary dampener 10 is in the rearward condition without altering the scope of the present invention.

When the rotary dampener 10 is in the rearward condition and the seat back 16 is in the locked condition, the dampener roller 122 is spaced circumferentially apart from the roller interface zone 204 on the leaf spring 182, as shown in FIG. 9. As such, the leaf spring 182 is not applying a dampening force onto the dampener roller 122. In addition, the tab 146 of the clock spring 142 is frictionally engaged with the engagement surface 114 on the actuating tab 112 and spaced circumferentially apart from the leading surface 134 on the spring stop 132. As viewed in FIG. 9, the clock spring 142 applies a clockwise spring force (arrow 232) and spring-biases the actuating bracket 106 in a clockwise direction (arrow 233) when the clock spring tab 146 is frictionally engaged with the actuating tab 112. Referring to FIGS. 1, 5, 9, and 12, the clockwise spring force (arrow 232) applied by the clock spring 142 on to the actuating tab 112 spring-biases the outboard cover 154 in the clockwise direction (arrow 233) which spring-biases the seat back 16 in a forward rotational direction 234 (FIGS. 1 and 12) since the actuating tab 112 is fixedly coupled to the bracket slot 164 in the outboard cover 154 and the attach flange 174 is fixedly coupled to the side bracket 25. However, the lock mechanism (not shown) prevents the seat back 16 from being repositioned by the rotary dampener 10 while the seat back 16 is in the locked condition.

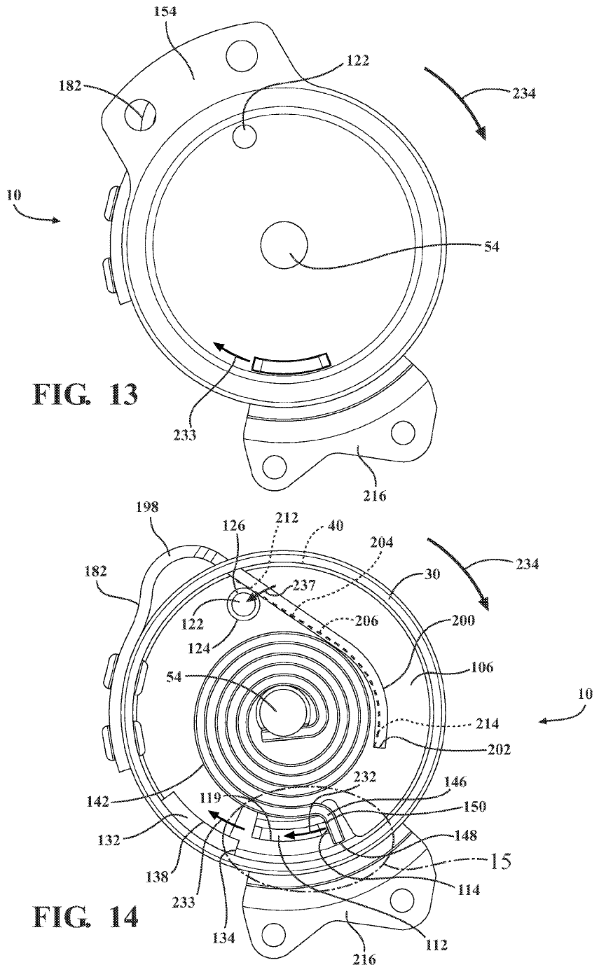

When the seat back 16 is in the reclined position 27 (FIG. 12) with the seat back 16 in the locked condition and the rotary dampener 10 in the rearward condition (FIGS. 5 and 9), the occupant initiates a return-to-upright process by unlocking the seat back 16. After the seat back 16 is unlocked, the clockwise spring force (arrow 232) applied by the clock spring 142 onto the actuating tab 112 in the rotary dampener 10 causes the actuating bracket 106 to rotate in the clockwise direction (arrow 233) which in turn causes the seat back 16 to pivot forward (arrow 234) towards the upright position 28, as further illustrated by arrow segment 236 in FIG. 12. The forward rotation of the seat back 16 is undampened as the seat back 16 rotates forward from the reclined position 27 towards the upright position 28 during arrow segment 236 since the clock spring 142 is engaged with the actuating bracket 106 and the dampener roller 122 is disengaged from the roller interface zone 204 on the leaf spring 182. The seat back 16 is relocked after the seat back 16 is in the upright position 28 and the rotary dampener 10 is in the upright condition shown in FIGS. 13 and 14.

When the rotary dampener 10 is in the upright condition (FIGS. 13 and 14), the tab 146 on the clock spring 142 is frictionally engaged with the engagement surface 114 on the actuating tab 112 and spaced apart from the leading surface 134 of the spring stop 132. The tab 146 on the clock spring 142 continues to apply the clockwise spring force (arrow 232) on the actuating tab 112. However, the seat back 16 is retained in the upright position 28 while the seat back 16 is in the locked condition. In addition, the dampener roller 122 is frictionally engaged with the minimum dampening location 212 along the roller interface zone 204 on the leaf spring 182. As viewed in FIG. 14, the leaf spring 182 applies a counterclockwise dampening force (arrow 237) in a rearward rotational direction onto the dampener roller 122 when the dampener roller 122 is in contact with the leaf spring 182. The magnitude of the counterclockwise dampening force (arrow 237) applied onto the dampener roller 122 is based in part on the relative position of the dampener roller 122 along the roller interface zone 204 with a minimum dampening force applied near the minimum dampening location 212 and a maximum dampening force applied near the maximum dampening location 214. Further, the minimum dampening force is less than the maximum dampening force. It will be appreciated that the magnitude of the counterclockwise dampening force (arrow 237) applied along the roller interface zone 204 might be adjusted by adjusting the contour and relative position of the curved portion 200 of the leaf spring 182.

When the seat back 16 is in the upright position 28 (FIG. 12) and in the locked condition with the rotary dampener 10 in the upright condition (FIGS. 13 and 14), the occupant initiates a fold flat process by unlocking the seat back 16. After the seat back 16 is unlocked, the clockwise spring force (arrow 232) applied by the clock spring 142 onto the actuating tab 112 causes the seat back 16 to pivot in the forward direction (arrow 234) towards the fold flat position 29, as further illustrated by arrow segment 238 in FIG. 12. As viewed in FIG. 14, the leaf spring 182 applies a minimum counterclockwise dampening force (arrow 237) onto the dampener roller 122 since the dampener roller 122 is in contact with the minimum dampening location 212 along the roller interface zone 204. The seat back 16 continues to rotate in the forward direction (arrow 234) since the minimum dampening force (arrow 237) in the counterclockwise direction is less than the clockwise spring force (arrow 232) applied by the clock spring 142. The forward rotation (arrow 234) of the seat back 16 during arrow segment 238 is generally undampened forward rotation after the clock spring 142 disengages from the actuating tab 112 and before the dampener roller 122 engages with the leaf spring 182. It will be appreciated that the dampener roller 122 might engage with the leaf spring 182 before or after the clock spring 142 disengages from the actuating tab 112 without altering the scope of the present invention.

Referring to FIG. 15, as the seat back 16 rotates past vertical 240 (shown as seat back position 241 in FIG. 12 and further described as a fold flat transition position), the tab 146 on the clock spring 142 frictionally engages with the leading surface 134 of the spring stop 132 and disengages from the actuating tab 112. The clock spring 142 no longer applies the clockwise spring force (arrow 232) on to the actuating tab 112 after the clock spring 142 engages with the spring stop 132. After the seat back 16 rotates forward (arrow 234) past vertical 240, gravity causes the seat back 16 to continue to rotate forward towards the fold flat position 29, as illustrated by arrow segment 242 in FIG. 12. The forward rotation (arrow 234) of the seat back 16 in response to gravity during arrow segment 242 also causes the actuating tab 112 to rotate clockwise (arrow 233) past the spring stop 132, as viewed in FIG. 15.

Referring to FIG. 12, if the forward rotational velocity of the seat back 16 was undampened, the weight of the seat back 16 would cause the forward rotational velocity of the seat back 16 to increase as the seat back 16 rotates past vertical 240 (seat back position 241), through a mid-rotational position (shown as a seat back position 243), and towards the fold flat position 29. The leaf spring 182 in the rotary dampener 10 applies a counterclockwise dampening force (arrow 237) configured to slow down the forward rotational velocity of the seat back 16 as the seat back 16 rotates towards the fold flat position 29. In addition, the leaf spring 182 applies a maximum amount of counterclockwise dampening force (arrow 237) as the seat back 16 approaches the fold flat position 29 (illustrated as seat back position 243). As such, the rotary dampener 10 applies the full dampening effect as the seat back 16 approaches the fold flat position 29.

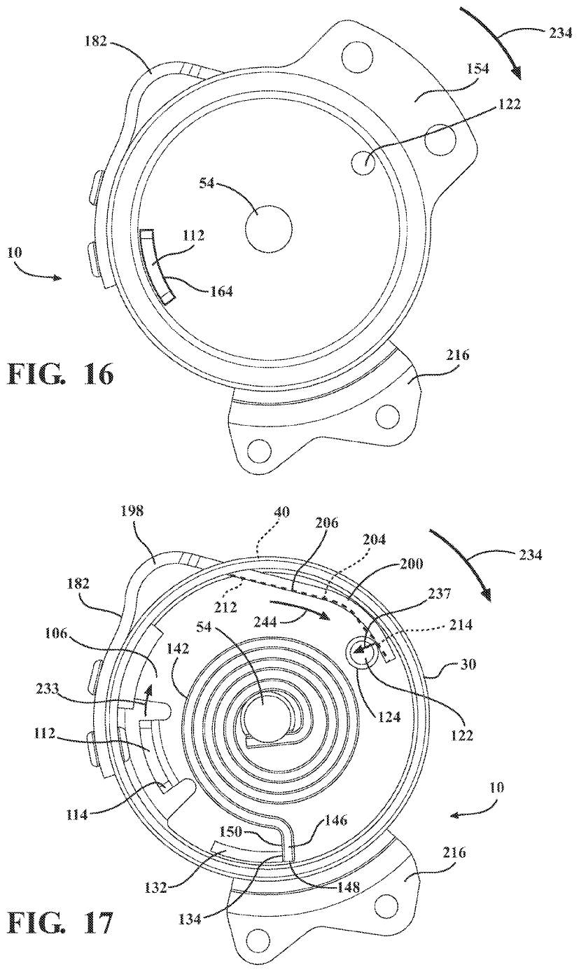

Referring to FIGS. 16 and 17, as the actuating tab 112 rotates in the clockwise direction (arrow 233) in response to the seat back 16 rotating forward (arrow 234) during arrow segment 242 (FIG. 12), the dampener roller 122 travels along the roller interface zone 204 (arrow 244) in a clockwise direction towards the maximum dampening location 214. The counterclockwise dampening force (arrow 237) applied by the leaf spring 182 on to the dampener roller 122 dampens the clockwise rotation (arrow 233) of the actuating tab 112 which also dampens the forward rotational velocity of the seat back 16. The maximum amount of counterclockwise dampening force (arrow 237) is applied to the dampener roller 122 as the dampener roller 122 engages with the maximum dampening location 214 on the leaf spring 182 and as the seat back 16 approaches the fold flat position 29. The seat back 16 has dampened forward rotation as the seat back 16 rotates through arrow segment 242 since the clock spring 142 is disengaged from the actuating tab 112 and the dampener roller 122 is engaged with the leaf spring 182.

The process is reversed to return the seat back 16 to the upright position 28 from the fold flat position 29. Referring to FIG. 12, when the seat back 16 is in the fold flat position 29, the occupant rotates the seat back 16 in a rearward rotational direction (arrow 234′) which returns the seat back 16 to the upright position 28. The clock spring 142 does not apply a spring force to the seat back 16 in the forward direction as the seat back 16 is rotated rearward (arrow 234′) while the clock spring 142 is engaged with the spring stop 132 and disengaged from the actuating tab 112. The clock spring 142 disengages from the spring stop 132 and engages with the actuating tab 112 as the seat back 16 returns to the upright position 28. Next, the lock mechanism is relocked when the seat back 16 returns to the upright position 28.

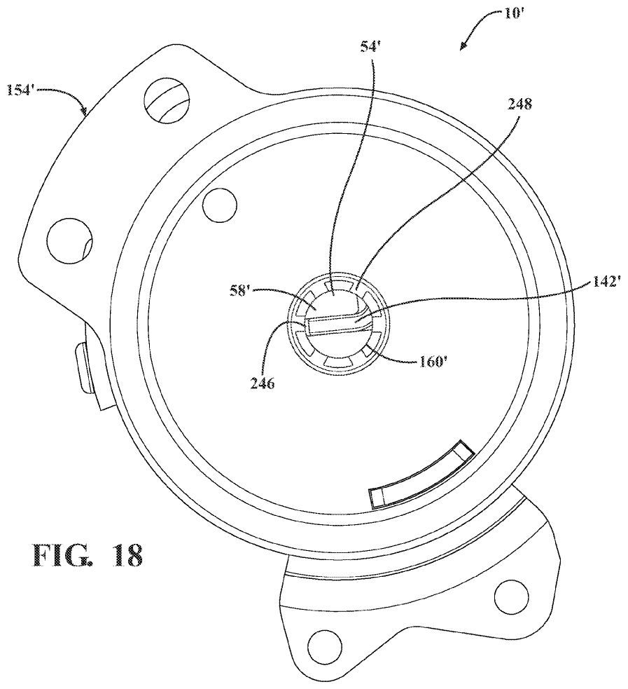

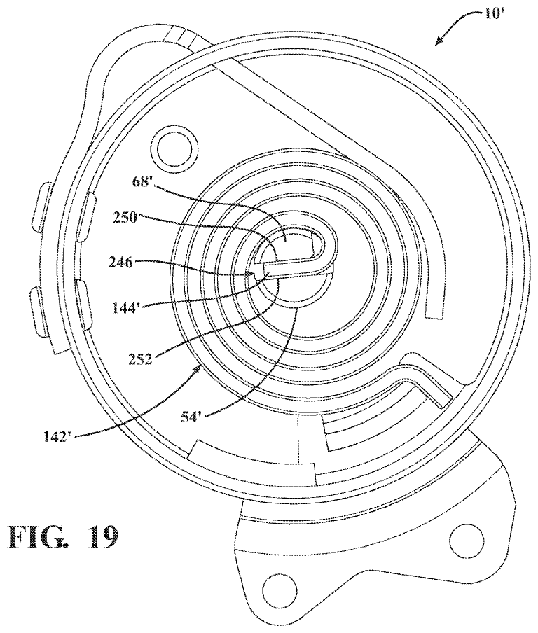

A second embodiment of the rotary dampener 10′ is shown in FIGS. 18 and 19, where like primed reference numerals represent similar elements as those described above. The rotary dampener 10′ of the second embodiment includes a modified pivot pin 54′ having a spring slot 246 and a circlip 248 fixedly coupled to the pivot pin 54′. Only significant differences between the two embodiments are reflected in the Figures and the description below.

Referring to FIGS. 18 and 19, the pivot pin 54′ includes the spring slot 246 extending radially through the spring arbor 68′ and having opposing slot walls 250, 252. The inner end 144′ of the clock spring 142′ is inserted into the spring slot 246 in the spring arbor 68′ which fixedly couples the inner end 144′ of the clock spring 142′ to the pivot pin 54′.

Depicted in FIG. 18, the rotary dampener 10′ also includes the circlip 248 configured to frictionally engage with the outboard end 58′ of the pivot pin 54′. During assembly, the outboard end 58′ of the pivot pin 54′ is inserted through the pivot hole 160′ in the outboard cover 154′. Next, the circlip 248 is pressed onto the outboard end 58′ of the pivot pin 54 to pivotably couple the outboard cover 154′ to the pivot pin 54′.

As discussed above, the rotary dampener 10, 10′ of the present invention includes a leaf spring 182 fixedly coupled to an inboard cover 30 which is fixedly coupled to a cushion bracket 22 on a seat assembly 12, a pivot pin 54, 54′ fixedly coupled to the inboard cover 30, an actuating bracket 106 pivotably coupled to the pivot pin 54, 54′, and a clock spring 142 having one end fixedly coupled to the pivot pin 54, 54′ and an outer end 148 configured to rotationally bias the actuating bracket 106. In addition, the rotary dampener 10, 10′ includes a dampener roller 122 operatively coupled to the actuating bracket 106 and configured to frictionally engage with the leaf spring 182 as the actuating bracket 106 is rotated. Further, the rotary dampener 10, 10′ includes an outboard cover 154 pivotably coupled to the pivot pin 54, 54′, fixedly coupled to the actuating bracket 106, and fixedly coupled to the side bracket 25 of the seat assembly 12. The rotary dampener 10, 10′ also includes a spring stop 132 configured to disengage the clock spring 142 from the actuating bracket 106 as the actuating bracket 106 rotates. In operation, the rotary dampener 10, 10′ is configured to spring-bias the seat back 16 towards an upright position 28 from a reclined position 27 and to then dampen the forward rotational velocity of the seat back 16 as the seat back 16 is rotated from the upright position 28 towards a fold flat position 29.

The invention has been described in an illustrative manner, and it is to be understood that the terminology, which has been used, is intended to be in the nature of words of description rather than of limitation. Many modifications and variations of the present invention are possible in light of the above teachings. It is, therefore, to be understood that within the scope of the appended claims, the invention may be practiced other than as specifically described.

What is claimed is:

1. A rotary dampener for an automotive seat assembly, comprising:
an inboard cover;
a pivot pin fixedly coupled to the inboard cover;
an actuating bracket pivotably coupled to the pivot pin and including an actuating tab;
a leaf spring having a head end fixedly coupled to the inboard cover and a free end spaced apart from the head end;
a dampener roller coupled to the actuating bracket and configured to selectively engage with the leaf spring as the actuating bracket rotates in a forward rotational direction and disengage from the leaf spring as the actuating bracket rotates in a rearward rotational direction opposite the forward rotational direction; and
an outboard cover pivotably coupled to the pivot pin and fixedly coupled to the actuating tab such that the outboard cover and the actuating bracket rotate together;
wherein when the outboard cover is rotated relative to the inboard cover in the forward rotational direction, the rotary dampener dampens a rotational velocity of the outboard cover while the dampener roller is engaged with the leaf spring and the rotational velocity is undampened while the dampener roller is disengaged from the leaf spring.

2. The rotary dampener as set forth in claim 1, wherein:
the leaf spring includes a roller interface zone extending along a portion of the leaf spring; and
the leaf spring applies a dampening force onto the dampener roller in the rearward rotational direction while the dampener roller is engaged with the roller interface zone.

3. The rotary dampener as set forth in claim 2, wherein:
the roller interface zone includes a minimum dampening location spaced apart from a maximum dampening location; and
an amount of dampening force applied by the leaf spring onto the dampener roller in the rearward rotational direction is greater while the dampener roller is engaged with the maximum dampening location than while the dampener roller is engaged with the minimum dampening location.

4. The rotary dampener as set forth in claim 3, wherein:
an amount of dampening of the rotational velocity applied by the rotary dampener as the outboard cover is rotated relative to the inboard cover in the forward rotational direction is greater while the dampener roller is frictionally engaged with the maximum dampening location than while the dampener roller is frictionally engaged with the minimum dampening location.

5. The rotary dampener as set forth in claim 4, further comprising:
a clock spring having an inner end fixedly coupled to the pivot pin and an outer end configured to frictionally engage with the actuating tab;
wherein the clock spring spring-biases the actuating bracket in the forward rotational direction while the outer end is frictionally engaged with the actuating tab.

6. The rotary dampener as set forth in claim 5, wherein:
the clock spring spring-biases the outboard cover to rotate in the forward rotational direction while the outer end is frictionally engaged with the actuating tab.

7. The rotary dampener as set forth in claim 6, further comprising:
a spring stop fixedly coupled to the inboard cover and configured to frictionally engage with the outer end of the clock spring;
wherein the clock spring spring-biases the outboard cover in the forward rotational direction while the outer end of the clock spring is engaged with the actuating tab and disengaged from the spring stop; and
wherein the clock spring is disengaged from the actuating tab while the outer end of the clock spring is engaged with the spring stop.

8. The rotary dampener as set forth in claim 7, wherein:
the dampener roller comprises a roller pin extending axially through a roller; and
the roller pin includes one end fixedly coupled to the actuating bracket and an opposing end fixedly coupled to the outboard cover.

9. The rotary dampener as set forth in claim 8, wherein:
the inboard cover is configured to be fixedly coupled to a first component on a seat assembly;
the outboard cover is configured to be fixedly coupled to a second component on the seat assembly; and
one or more of the first component and the second component is pivotable relative to the other one of the first component and the second component;
wherein the rotary dampener dampens the rotational velocity when one of the first component and the second component is pivoted relative to the other one of the first component and the second component and the dampener roller is engaged with the roller interface zone on the leaf spring.

10. The rotary dampener as set forth in claim 8, wherein:
the inboard cover includes an inboard wall, a cylindrical wall extending circumferentially around the inboard wall, and a slot extending circumferentially along a portion of the cylindrical wall; and
the leaf spring extends through the slot.

11. A seat assembly for use in an automotive vehicle, comprising:
a seat cushion;
a seat back pivotably coupled to the seat cushion and pivotable between a first seat back position and a second seat back position; and
a rotary dampener operatively coupled between the seat back and the seat cushion and including an inboard cover fixedly coupled to the seat cushion, a pivot pin fixedly coupled to the inboard cover, an actuating bracket pivotably coupled to the pivot pin and including an actuating tab, a leaf spring having a head end fixedly coupled to the inboard cover and a free end spaced apart from the head end, a dampener roller coupled to the actuating bracket and configured to selectively engage with the leaf spring as the actuating bracket rotates in a forward rotational direction, and an outboard cover pivotably coupled to the pivot pin, fixedly coupled to the actuating tab such that the outboard cover and the actuating bracket rotate together, and fixedly coupled to the seat back;
wherein the rotary dampener dampens a rotational velocity of the seat back when the seat back is rotated in the forward rotational direction while the dampener roller is engaged with the leaf spring and the rotational velocity is undampened while the dampener roller is disengaged from the leaf spring.

12. The seat assembly as set forth in claim 11, wherein:
the leaf spring includes a roller interface zone extending along a portion of the leaf spring; and
the leaf spring applies a dampening force onto the dampener roller in a rearward rotational direction opposite the forward rotational direction while the dampener roller is engaged with the roller interface zone.

13. The seat assembly as set forth in claim 12, wherein:
the roller interface zone includes a minimum dampening location spaced apart from a maximum dampening location; and
an amount of dampening force applied by the leaf spring onto the dampener roller in the rearward rotational direction is greater while the dampener roller is engaged with the maximum dampening location than while the dampener roller is engaged with the minimum dampening location.

14. The seat assembly as set forth in claim 13, wherein:
an amount of dampening of the rotational velocity applied by the rotary dampener as the seat back is rotated relative to the seat cushion in the forward rotational direction is greater while the dampener roller is frictionally engaged with the maximum dampening location than while the dampener roller is frictionally engaged with the minimum dampening location.

15. The seat assembly as set forth in claim 14, the rotary dampener further comprising:
a clock spring having an inner end fixedly coupled to the pivot pin and an outer end configured to frictionally engage with the actuating tab;
wherein the clock spring spring-biases the actuating bracket in the forward rotational direction while the outer end is frictionally engaged with the actuating tab.

16. The seat assembly as set forth in claim 15, the rotary dampener further comprising:
a spring stop fixedly coupled to the inboard cover and configured to frictionally engage with the outer end of the clock spring;
wherein the clock spring spring-biases the outboard cover in the forward rotational direction while the outer end of the clock spring is engaged with the actuating tab and disengaged from the spring stop; and
wherein the clock spring is disengaged from the actuating tab while the outer end of the clock spring is engaged with the spring stop.

17. The seat assembly as set forth in claim 16, wherein:
the dampener roller comprises a roller pin extending axially through a roller; and
the roller pin includes one end fixedly coupled to the actuating bracket and an opposing end fixedly coupled to the outboard cover.

18. The seat assembly as set forth in claim 11, further comprising a second rotary dampener operatively coupled between the seat back and the seat cushion.
